(19) United States
(12) Patent Application Publication
(10) Pub. No.: US 2024/0054473 A1
(43) Pub. Date: Feb. 15, 2024

(54) METHODS AND SYSTEMS FOR EXTENDING INSTALLMENT OPTIONS

(71) Applicant: MASTERCARD INTERNATIONAL INCORPORATED, PURCHASE, NY (US)

(72) Inventors: Stephen Bongner, Dardenne Prairie, MO (US); Rahul Churiwala, Toronto (CA); Kevin Dorfer, Toronto (CA); Shelby Archer, Bainbridge Island, WA (US); Lingxin Zhao, O'Fallon, MO (US)

(21) Appl. No.: 17/888,346

(22) Filed: Aug. 15, 2022

(51) Int. Cl. G06Q 20/24; H04L 9/32; G06Q 40/02

(52) U.S. Cl. CPC G06Q 20/24; H04L 9/3239; G06Q 40/025

(57) ABSTRACT

Systems and methods are provided for use in providing users with options at points of interaction. One example method includes posting a record for an installment option to an immutable data structure, where the record includes a total amount, payment terms associated with multiple installments, a first hashed value associated with a first party, and an identifier of the first party. The method also includes receiving a request related to the record, where the request includes a secret and a second hashed value, and validating the request based on the secret and the first hashed value included in the immutable data structure. The method then includes, based on validation of the request, coordinating a fund transfer consistent with the request and updating the record included in the immutable data structure to include the second hashed value in association with the identifier of the first party.

### FIELD

The present disclosure generally relates to methods and systems for use in extending (e.g., implementing, providing, making available, etc.) installment options to users, and in particular, to methods and systems for use in extending installment options through data structure records.

### BACKGROUND

This section provides background information related to the present disclosure which is not necessarily prior art.

Users are known to acquire products (e.g., goods and services, etc.) through purchases from merchants. Often, the users fund the purchases through cash, credit, or checks, whereby the users pay for the purchases, in full, and take delivery of the products. When the users pay with credit cards, for example, the users may pay later by making one or more payments to issuers of the credit cards to reimburse the issuers for the full amounts of the purchases (with interest applied according to terms).

In addition, it is known for merchants to offer layaway programs to users, whereby the users pay the merchants for the products over a period of time and the products are held by the merchants until all payments are made.

### DRAWINGS

The drawings described herein are for illustrative purposes only of selected embodiments and not all possible implementations, and are not intended to limit the scope of the present disclosure.

FIG. 1 is an example system of the present disclosure operable to provide users with installment options;

FIG. 2 is a block diagram of an example computing device that may be used in the system of FIG. 1; and

FIG. 3 is an example method, which may be used with the system of FIG. 1, for providing a user with installment options at a virtual location in connection with the purchase of a product.

Corresponding reference numerals indicate corresponding parts throughout the several views of the drawings.

### DETAILED DESCRIPTION

Example embodiments will now be described more fully with reference to the accompanying drawings.

Installment options may be provided to consumers through services that vary from merchant to merchant. Consequently, consumer experiences with regard to such installment options are often different from merchant to merchant. In addition, documentation may be a challenge for some merchants, in connecting with lenders and memorializing agreements in a manner which is centralized and accessible. Uniquely, the systems and methods herein provide for implementation of installment contracts in an immutable data structure, such as, for example, a blockchain structure, etc. In particular, for example, an installment host coordinates between acquirers and lenders to deploy installment contracts to an immutable data structure, which enables the lenders to securely put funds into the contracts, and permits the acquirers to securely pull funds from the contracts. In this manner, installment options may be extended to merchants in an efficient and secure manner via the further interactions of the installment host, acquirers, lenders, and immutable data structure.

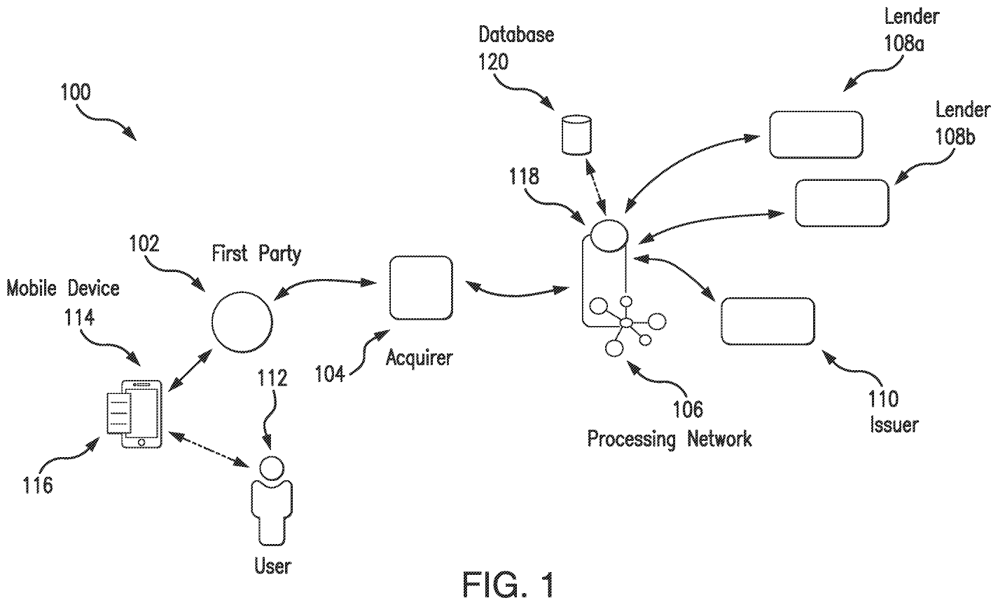

FIG. 1 illustrates an example system 100 in which one or more aspects of the present disclosure may be implemented. Although the system 100 is presented in one arrangement, other embodiments may include systems arranged otherwise depending, for example, on parties included in the system 100, processing of installment payment options, privacy rules and requirements, etc.

The illustrated system 100 generally includes a first party 102, an acquirer 104 associated with the first party 102, a processing network 106, multiple lenders 108a-b, and an issuer 110 associated with a user 112, each of which is coupled to (and is in communication with) one or more networks (as generally indicated by the arrowed lines in FIG. 1). The one or more networks may each include, without limitation, a local area network (LAN), a wide area network (WAN) (e.g., the Internet, etc.), a mobile network, a virtual network, and/or another suitable public and/or private network capable of supporting communication among two or more of the parts of the system 100 illustrated in FIG. 1, or any combination thereof. For example, one such network may include multiple different networks, such as a private payment transaction network made accessible by the processing network 106 to the acquirer 104 and the issuer 110 and, separately, the public Internet, which is accessible, as desired, to the first party 102, the acquirer 104, the lenders 108a-b, the issuer 110, and a user 112 (or specifically, a mobile device 114 associated with the user 112), etc.

The first party 102 in the system 100 is configured to offer for sale and to sell products (e.g., goods, services, etc.) to consumers including, for example, the user 112. In connection therewith, the first party 102 may include a merchant (e.g., a retailer, etc.), service provider, etc. The first party 102 may be disposed and/or accessible at one or more physical locations, such as, for example, at one or more brick-and-mortar locations, and/or at one or more virtual locations, for example, via one or more e-commerce platforms (e.g., a website, network-based application, etc.). In this specific example embodiment, the user 112 interacts with the first party 102 through an e-commerce website, via the mobile device 114 (e.g., at a browser 116 of the mobile device 114, etc.). In connection therewith, the user 112 may add one or more products offered for sale by the first party 102 to a virtual shopping cart at the e-commerce website of the first party 102, and then select an option to checkout to purchase the one or more products, as described in more detail below.

The acquirer 104 and the issuer 110 of the system 100 are financial institutions, which commonly issue accounts to various parties. In the example embodiment of FIG. 1, the acquirer 104 issued an account to the first party 102, into which funds for purchases are deposited, either by the first party 102 or through the processing network 106 for electronic transactions (e.g., credit or debit transactions, etc.). Similarly, the issuer 110 issued a payment account to the user 112, which may include, for example, a credit account, debit account, etc. The user 112 is then permitted to present the account, for example, through a payment card or virtual wallet, etc., to the first party 102, or other merchants, service providers, etc., in connection with purchasing products, or as explained below, for purchasing the products directly, or initiating funding of the purchases through installment options, etc. The payment account is associated with a payment credential, such as, for example, a primary account number (PAN), or token, etc., which is unique to the payment account and the issuer 110 (i.e., to uniquely identify the payment account, etc.).

The lenders 108a-b are also financial institutions, which commonly lend funds to users, including, for example, the user 112. In this example embodiment, the lenders 108a-b each are registered with an installment host 118, whereby each is configured to participate in installment services, coordinated through the installment host 118. In connection therewith, the lenders 108a-b are each configured to compile and submit installment options to the installment host 118. The installment options may include, without limitation, any and all terms associated with installment payments for products, including, for example, one or more of frequency of payments, intervals between payments, interest rates, amount limits/thresholds, qualifications for users, qualifications for merchants/purchases (e.g., by type, region, etc.), qualifications for products, etc. For example, one installment option may be for 10 monthly payments of 10% of a total product price, with 1% interest, for all consumers for electronics purchases under $1000, etc., while a different installment option may include five bi-monthly payments with no interest for clothing purchases, in one or more regions, etc. In connection therewith, various different criteria may be used to determine which installment options to provide to consumers and/or content of installment options including, for example, locations of the consumers, locations of the transactions, product/transaction amounts, classification of the product as presale or existing stock, any agreement between the lenders 108a-b and the processing network 106 and/or installment host 118, etc.

The processing network 106 is configured to coordinate transactions between acquirers (e.g., the acquirer 104, etc.), on behalf of payees (e.g., merchants including the first party 102, etc.), and issuers (e.g., the issuer 110, etc.), on behalf of payers (e.g., the user 112, etc.), etc. The processing network 106 may include, for example, the MASTERCARD, VISA, or AMERICAN EXPRESS processing network, etc.

In this example embodiment, the processing network 106 is associated with the installment host 118, which is configured to manage installment plans from the different lenders 108a-b. It should be understood that in some embodiments the installment host 118 may be a standalone device that is separate, or at least partially separate, from the processing network 106. However, in at least one embodiment, the installment host 118 may be integrated, in whole or in part, with the processing network 106. As further shown in FIG. 1, the installment host 118 is associated with a database 120, which is illustrated as separate from the installment host 118, but may be included therein, in whole or in part, in various system embodiments, etc.

The database 120 is an immutable data structure, such as, for example, a blockchain data structure that is accessible, via the installment host 118, to the parties shown in FIG. 1, and others. By being immutable, the database 120 is configured to write records or entries therein, where the records or entries are non-changeable without being apparent in the chain of records or entries. It should be appreciated that the database 120 may be a distributed database (e.g., physically or logically across multiple devices, regions, etc.), or may be a centralized database, as desired.

That said, in response to the installment options, from the lenders 108a-b, the installment host 118 is configured to store the options in memory, whereby the installment options may be offered to participants. In addition, the installment host 118 is configured to access user profiles for different users, each of which includes identifying information for the particular user. Alternatively, the installment host 118 may include such user profiles in memory thereof. In this manner, the installment host 118 is also an identity provider, or may be integrated (in whole or in part) with an identity provider (or an identity service). The user profiles are stored in memory, which is separate and distinct from the database 120. In this embodiment, the user 112 is registered with the installment host 118 (or identify provider) whereby a user profile associated with the user 112 is accessible to (or included in memory of) the installment host 118.

In this example embodiment, the first party 102 and associated acquirer 104 are registered participants in the installment service(s) offered by the installment host 118. As such, the first party 102 and/or the acquirer 104 has identified or selected different installment options from the installment host 118, as received from the lenders 108a-b, for use with purchases at the first party 102. In this example, the first party 102 may select installment options suited to the purchases, which are typical at the first party 102, for example, by amount, type, user criteria, etc. In another example, rather than the first party 102 or the acquirer 104 choosing/selecting, the installment host 118 may be configured to match the transaction to the installment option suited therefore (e.g., based on similar or different criteria, etc.). In connection therewith, the website or other virtual location of the first party 102 is configured to present an installment pay choice at checkout, which is selectable by users, including the user 112. Similarly, a point of sale (POS) terminal at the first party 102 (e.g., a physical location, etc.) may be configured to offer the installment pay choice at checkout.

It should be understood that the installment host 118 is configured to provide the selected installment options (regardless of the selecting party) to the acquirer 104 and/or first party 102, and the acquirer 104 and/or first party 102 is configured to store the same.

When the user 112, for example, opts to select the installment pay choice (e.g., during checkout, etc.), the acquirer 104 and/or first party 102 is configured, through the website or an associated application programming interface (API), or lightbox, to present the installment options to the user 112. The user 112 is then able to select one of the installment options to fund the purchase at the first party 102, and further provide identifying information for the user 112 in connection with the purchase. In turn, the acquirer 104 and/or first party 102 is configured to submit the selection of the installment option, and the identifying information to the installment host 118.

The installment host 118 is configured to access a user profile associated with the user 112, and to identify contact information for the user 112 (e.g., phone number, email address, application ID of an identity application (or virtual wallet) in the mobile device 114, etc.), and to request consent from the user 112, at the mobile device 114. The consent request may include indicators of the installment purchase (e.g., terms, amount, first party 102, etc.). In response, the user 112 reviews the consent request and provides consent to the installment host 118, via the mobile device 114. It should be appreciated that the installment host 118 may be further configured to verify the installment option.

In turn, the installment host 118 is configured to share the identifying information, as consented by the user 112, to the acquirer 104.

The acquirer 104 is configured to then post a contract indicative of terms of the installment option, and limited information about the user 112, to the database 120. The acquirer 104 may be configured, for example, to post the contract, via an API associated with the database 120 (and exposed by the installment host 118). The contract includes certain details such as, for example, those shown below in Table 1. As shown, the contract (or contract record) may include a total amount, a balance due, a minimum payment, a number of payments, an interval of the payments, and a due date for the first payment (e.g., apart from a contemporaneous payment, etc.), etc., and also a lender hash for a lender involved in the option, a lender identifier for the lender, an issuer hash for the issuer 110 involved in the option and an issuer identifier, etc. The issuer hash is generally provided by the issuer 110 on (or around or prior to) creation of the contract. The lender hash is a hashed value of a secret, which is known to the lender 108b, for instance, in this example. The lender hash, then, is provided by the lender (or potentially the installment host 118) when the lender puts money into the contract (or prior thereto) (and when the lender 108b pulls funds out of the contract). The hashed values are based on a secret known to the respective party, i.e., the issuer 110 or the lender 108b, and may be based on a version of the secure hashing algorithm or SHA (e.g., SHA-2, SHA-3, etc.) or a RIPEMD-160 hashing algorithm, etc.

TABLE 1

```
contract pentad_flamboyant {
  struct Loan {
    uint256 amount;
    uint256 balance;
    uint16 minPayment;
    uint8 payments;
    uint8 paymentInterval;
    uint256 firstPaymentDue;
  }
  bytes32 lenderHash;
  address payable lender;
  bytes32 issuerHash;
  address payable issuer;
  Loan public loan;
```

It should be appreciated that more or fewer details (e.g., more or fewer details than shown in Table 1, etc.) may be included in other example contracts to be posted to the database 120.

In response to the post by the acquirer 104, the database 120 is configured to store the contract in a record (e.g., as a contract record, etc.).

Once the contract is stored, the acquirer 104 is configured to request payment in the amount of the installment option, i.e., the total amount. The request for payment is submitted, again, via an API call associated with the database 120 and hosted by the installment host 118. The request includes the record identifier for the contract, a secret (known to the acquirer 104, which was the basis of the hashed value included in the contract) and also a new hash based on a new, different secret known only to the acquirer 104. In response, the installment host 118 is configured to validate the request by hashing the secret from the acquirer 104, and to compare the newly hashed secret to the hash included in the contract.

When the secret is validated, the installment host 118 is configured to submit the payment request to the lender 108b, in this example, of the selected option. The lender 108b is configured to pay the total amount into the contract, via an API call to the database 120, for example, via the installment host 118. In this way, the contract (e.g., as a smart contract, etc.) is capable of holding the paid funds (e.g., as currency, as non-fungible tokens (NFTs), etc.). As such, the contract is effectively the owner of the paid funds (e.g., as far as the blockchain data structure re of the database 120 is concerned, etc.), until a party authorized to remove the funds from the contract does so, for example, the user 112. In this example embodiment, the party authorized to remove the funds from the contract must possess the key associated with the respective hash (e.g., the issuer hash, etc.). Upon receipt of the payment, the installment host 118 is configured to respond to the API request for payment, by paying the total amount to the acquirer 104, and also to store the new hash in place of the existing hash in the contract, via a new entry to the record in the database 120. Along with the new hash, the installment host 118 is configured to update the contract otherwise, as needed.

After the acquirer 104 is paid, as described above, payment by the user 112 of the contract, consistent with its terms, via the account issued by the issuer 110, to the lender 108b, for example, may proceed in a number of different manners. Payments for the installment option may be setup up between the user 112 and the lender 108b, as connected through the contract herein. Additionally, or alternatively, the acquirer 104 may be configured to initiate the installment payment(s) to the lender 108b, as repayment for the loan (i.e., payment from the lender to the acquirer 104, etc.) underlying the installment option.

When the payment(s) are made into the contract, consistent with the instalment option, the lender 108b is configured to (immediately, or at some later time) pull the payment(s) out of the contract, by requesting the funds with the secret underlying the lender hash included in the contract, via an API call to the database 120 exposed by the installment host 118.

In response, the installment host 118 is configured to validate the request by hashing the secret from the lender 108b (e.g., via the same algorithm, such as, for example, SHA-3, etc.), and to compare the newly hashed secret to the lender hash included in the contract. When the secret is validated, the installment host 118 is configured to pay out the funds in or payments to the contract to the lender 108b. In connection with paying out the funds, when the contract is not complete, the installment host 118 is configured to store the new hash from the lender 108b to validate the lender in a later interaction.

While the system 100 includes only one first party, one acquirer, two lenders and one issuer, it should be appreciated that numerous of these entities may be included in various system embodiments, while each is configured similar to the description above.

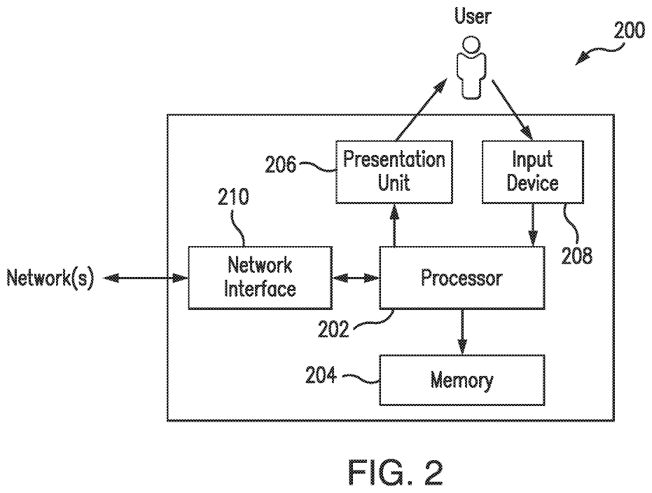

FIG. 2 illustrates an example computing device 200 that may be used in the system 100. The computing device 200 may include, for example, one or more servers, workstations, personal computers, laptops, tablets, smartphones, PDAs, terminals, virtual machines, etc. In addition, the computing device 200 may include a single computing device, or it may include multiple computing devices located in close proximity or distributed over a geographic region, so long as the computing devices are specifically configured to function as described herein. In the system 100 of FIG. 1, each of the first party 102, the acquirer 104, the processing network 106, the lenders 108a-b, the issuer 110, and the mobile device 114 may include or may be implemented in a computing device (or multiple computing devices) consistent with computing device 200 coupled to (and in communication with) one or more networks. That said, the system 100, or parts thereof, should not be understood to be limited to the computing device 200, as other computing devices may be employed in other system embodiments. In addition, different components and/or arrangements of components may be used in other computing devices.

Referring to FIG. 2, the example computing device 200 includes a processor 202 and a memory 204 coupled to (and in communication with) the processor 202. The processor 202 may include one or more processing units (e.g., in a multi-core configuration, etc.). For example, the processor 202 may include, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein.

The memory 204, as described herein, is one or more devices that permits data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable storage media. The memory 204 may be configured to store, without limitation, transaction data, installment options, hashed values, secrets, identifying data, and/or other types of data (and/or data structures) as needed and/or suitable for use as described herein. Furthermore, in various embodiments, computer-executable instructions may be stored in the memory 204 for execution by the processor 202 to cause the processor 202 to perform one or more of the functions described herein (e.g., one or more of the operations of method 300, etc.), such that the memory 204 is a physical, tangible, and non-transitory computer readable storage media. Such instructions often improve the efficiencies and/or performance of the processor 202 that is performing one or more of the various operations herein, whereby such performance may transform the computing device 200 into a special purpose computing device. It should be appreciated that the memory 204 may include a variety of different memories, each implemented in one or more of the operations or processes described herein.

In the example embodiment, the computing device 200 includes a presentation unit 206 that is coupled to (and that is in communication with) the processor 202 (however, it should be appreciated that the computing device 200 could include output devices other than the presentation unit 206, etc.). The presentation unit 206 outputs information (e.g., installment options, etc.), either visually or audibly, to a user of the computing device 200, for example, the user 112 in the system 100, etc. In connection therewith, various interfaces (e.g., as defined by network-based applications, etc.) may be displayed at computing device 200, and in particular at presentation unit 206, to display such information. The presentation unit 206 may include, without limitation, a liquid crystal display (LCD), a light-emitting diode (LED) display, an organic LED (OLED) display, an “electronic ink” display, speakers, etc. In some embodiments, the presentation unit 206 may include multiple devices.

The computing device 200 also includes an input device 208 that receives inputs from the user (i.e., user inputs) such as, for example, selections of installment options, etc. by the user 112, or inputs from other computing devices. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. Further, in various example embodiments, a touch screen, such as that included in a tablet, a smartphone, or similar device, may behave as both the presentation unit 206 and the input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to/with one or more different networks, including the network(s) of the system 100. Further, in some example embodiments, the computing device 200 may include the processor 202 and one or more network interfaces incorporated into or with the processor 202.

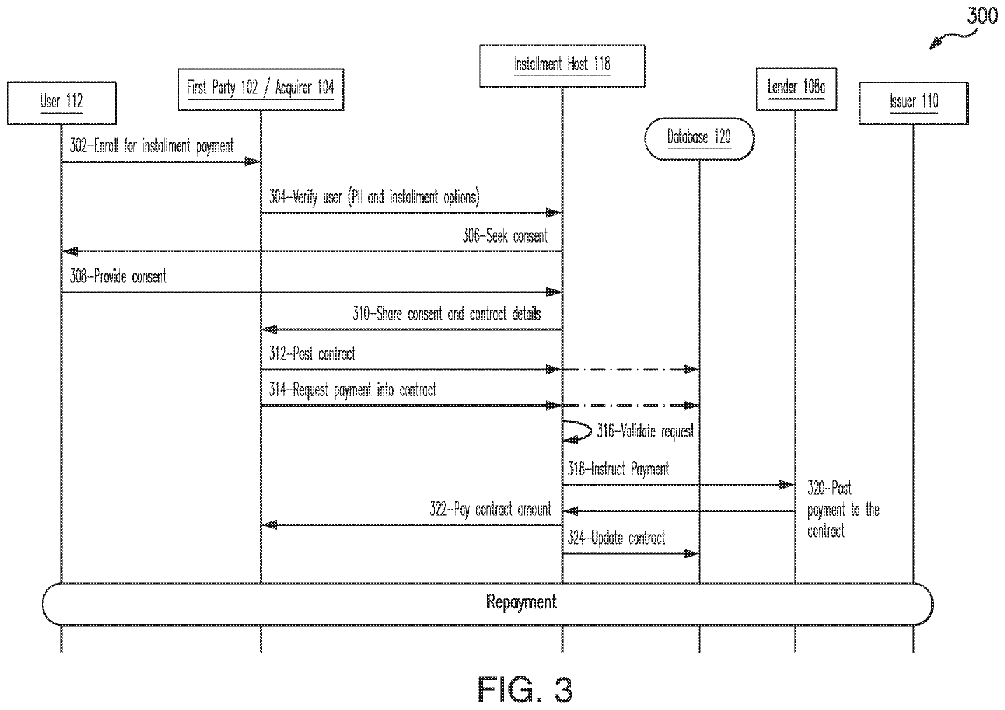

FIG. 3 illustrates an example method 300, for use in providing installment options, through immutable data structures. The example method 300 is described as implemented in the installment host 118, and the system 100, more generally. Additional reference is also made to the computing device 200. Nonetheless, it should be understood that the methods herein are not limited to the system 100 and/or the computing device 200. Likewise, the systems, devices, and interfaces herein should not be understood to be limited to the method 300.

At the outset, it should be appreciated that the user 112 has decided to purchase a product or service from the first party 102. As such, in this example, the user 112 adds the product or service to a shopping cart associated with a virtual location of the first party 102, and then selects to checkout.

In connection therewith, an option(s) (e.g., as part of the checkout interface, etc.) is presented to the user 112 to make installment payments for the purchase. In the method 300, the user 112 opts to enroll for installment payments for the purchase, via the mobile device 114 (e.g., through the virtual location of the first party 102, etc.), at 302. As part of opting to enroll, a number of installment options are displayed to the user 112, via the virtual location (or associated interface) to the user 112. The installment options may include a number of payments, intervals, amounts, etc., which are included in the options, along with, for example, an indication of the lender (e.g., “Installment Option A by Lender 108b,” etc.), and any suitable information regarding the installment option, or details the user 112 my want to know, etc. In opting to enroll, the user 112 may select one of the installment options, whereby the enrollment of the user 112 to the first party 102 and/or the acquirer 104 includes the installment option details. In the example method 300, the user 112 selects an installment option associated with lender 108a.

In turn, the first party 102 and/or the acquirer 104 verifies, at 304, the user 112 with the installment host 118, directly or with an identity service associated with the installment host 118.

In order to verify the user 112, the installment host 118 seeks, at 306, consent from the user 112 to share identifying information with the acquirer 104 (e.g., personal identifying information (PII), etc.). In particular, for example, the request to verify the user 112, from the acquirer 104, includes a name, mailing address, phone number, email address, etc., of the user 112, whereby the installment host 118 is permitted to retrieve a user profile associated with the user 112. The profile includes contact information for the user 112. As such, the installment host 118 seeks consent from the user 112, via the contact information (e.g., at the mobile device 114, etc.). The request for consent may include details of the installment option selected by the user 112 and/or details associated with the first party 102 and/or the purchase from the first party 102 (e.g., amount, etc.).

When the request is consistent with what is expected by the user 112 (e.g., installment details, amount, first party, etc.), the user 112 provides, at 308, consent to the installment host 118 to verify the user 112 and/or provide certain or limited identifying information to the acquirer 104.

The installment host 118, at 310, shares the consent and the installment details with the acquirer 104. The installment details may include, for example, a hashed secret of the lender 108b (or lender hash), for example, associated with the selected installment option (e.g., as generated by the installment host 118, as generated by the lender 108b and provided to the installment host 118, etc.).

At 312, the acquirer 104 posts (e.g., creates, etc.) a contract indicative of the installment option to the database 120, via the installment host 118 (e.g., an API exposed by the installment host 118, etc.). In particular, the acquirer 104 posts the total amount of the purchase, a balance due, a payment amount, a payment interval, a due date for one or more of the payments, an identifier and a hashed value for the acquirer 104, and an identifier and a hashed value for the lender 108b, along with an identifier of the user 112 (in a manner unique to the user 112) (e.g., name, address, email address, etc.). The hashed value for the acquirer 104 may be provided on creation of the contract to enable the acquirer 104 exclusively to get money the lender 108b puts into the contract. The hashed value for the lender 108b, then, may be provided when the lender puts the money into the contract (e.g., at 320 below, etc.). The posted contract, in total, may include any suitable information to recognize the obligation of the user 112. That said, it should be appreciated that certain information may be restricted, as the posted contract is essentially available to the public in certain embodiments

The database 120, as part of step 312, posts or stores the contract in an immutable record in the database 120, which includes a blockchain data structure in this example. A record identifier associated with the contract may be returned to the installment host 118 and also, potentially, the acquirer 104, the lender 108b, and the user 112.

Next, the acquirer 104 requests, at 314, that the lender 108a make a payment into the contract, in the amount of the total contract, to fund the purchase by the user 112 with the first party 102. The request includes an identification of the acquirer 104, the contract record in the database 120, the secret (known to the acquirer 104, which was the basis of the hashed value for the acquirer 104 included in the contract) and also a new hash based on a new, different secret known only to the acquirer 104, etc. The request for payment is submitted by the acquirer 104, again, via an API call associated with the database 120 and/or hosted by the installment host 118.

In response, the installment host 118 validates, at 316, the request by hashing the new secret from the acquirer 104, and comparing the hashed value to the hash included in the contract for the acquirer 104. When the request is valid, the hashed values match. When the request is invalid, the hashed values will not match.

When the request is validated, the installment host 118 submits, at 318, an instruction to make the payment to the lender 108a, in this example. The instruction may include a record identifier for the contract, whereby the lender 108b is able to review the contract at the database 120 (e.g., via an API call for the contract details, etc.), or the instruction itself may include the details of the contract. Based on the review and/or its prior registration/offer of the installment option, the lender 108a accepts the contract by posting or paying, at 320, the total amount into the contract, via an API call, to the database 120, via the installment host 118. The hashed value for the lender 108b, then, may also be provided when the lender puts the money into the contract.

Upon receipt of the payment, the installment host 118 responds, at 322, by paying the total amount to the acquirer 104. The installment host 118 also updates, at 324, the contract to reflect the payment being made, the contract being formed and the obligation of the user 112 to pay the installments. In doing so, the installment host 118 appends the detail of the payment request to the contract (including the new hashed value for the acquirer 104), via a new entry to the record in the database 120, whereby the secret is exposed to the public and the original hashed value is now useless to modify or impact the contract.

Subsequently, from time to time, the user 112, via the acquirer 104, the issuer 110, etc., may participate in repayment, as shown in FIG. 3, whereby payments are made to and from the contract in a similar manner. In short, the acquirer 104, for example, charges a payment account of the user 112, issued by the issuer 110, for an installment amount, and then pays an equal amount into the contract in the database 120. In doing so, the acquirer 104 again uses the hashed value in the record and adds a new hashed value to the contract. For each payment into the contract, the lender 108b may extract the funds, or the lender 108a may wait for multiple payments or all payments to extract the funds. In order to extract the funds, the lender 108a requests the funds in the contract be paid out. The request includes an identification of the lender 108a, the contract record in the database 120, the secret (known to the lender 108a, which was the basis of the hashed value included in the contract for the lender 108a) and also a new hash based on a new, different secret known only to the acquirer 104, etc. The request for payment is submitted, via an API call associated with the database 120 and/or hosted by the installment host 118.

In response, the installment host 118 validates the request by hashing the secret from the lender 108a, and comparing the hashed value to the hash included in the contract for the lender 108a. Again, when the request is valid, the hashed values match. When the request is invalid, the hashed values will not match.

When the request is validated, the installment host 118 pays out the funds to the lender 108b and updates the contract to reflect the payment being made. In doing so, the installment host 118 appends the detail of the payment request to the contract (including the new hashed value for the lender 108b (if the contract is not complete)), via a new entry to the record in the database 120, whereby the original hashed value and secret are exposed to the public and useless to modify or impact the contract.

In view of the above, the systems and methods herein provide for secure installment options to be provided to users, via acquirers, lenders and issuers associated with a first party and/or the users. The installment options leverage a database, such as, for example, a blockchain, which includes a public, immutable record in activity, to record the contract and payments made into and out of the contract. In this manner, the systems and methods herein provide a secure solution, which is uniquely transparent to the parties involved and efficient in communications therewith.

Again and as previously described, it should be appreciated that the functions described herein, in some embodiments, may be described in computer executable instructions stored on a computer readable media, and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the operations recited in the claims, for example: (a) posting a record for an installment option to an immutable data structure, the record including a total amount, payment terms associated with multiple installments, a first hashed value associated with a first party, and an identifier of the first party; (b) receiving a request related to the record, the request including a secret and a second hashed value; (c) validating the request based on the secret and the first hashed value included in the immutable data structure; and (d) based on validation of the request: (i) coordinating a fund transfer consistent with the request; and (ii) updating the record included in the immutable data structure to include the second hashed value in association with the identifier of the first party.

With that said, example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature, element or layer is referred to as being “on,” “engaged to,” “connected to,” “coupled to,” “included with,” “associated with,” or “in communication with” another feature, element or layer, it may be directly on, engaged, connected, coupled, associated, or in communication with/to the other feature, element or layer, or intervening features, elements or layers may be present. In contrast, when feature, element or layer is referred to as being “directly on,” “directly engaged to,” “directly connected to,” “directly coupled to,” “directly associated with,” or “directly in communication with” another feature, element or layer, there may be no intervening features, elements or layers present. Other words used to describe the relationship between elements should be interpreted in a like fashion (e.g., “between” versus “directly between,” “adjacent” versus “directly adjacent,” etc.). As used herein, the term “and/or” and the phrase “at least one of” includes any and all combinations of one or more of the associated listed items.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

Although the terms first, second, third, etc. may be used herein to describe various elements and operations, these elements and operations should not be limited by these terms. These terms may be only used to distinguish one element or operation from another element or operation. Terms such as “first,” “second,” and other numerical terms when used herein do not imply a sequence or order unless clearly indicated by the context. Thus, a first element operation could be termed a second element or operation without departing from the teachings of the example embodiments.

The foregoing description of example embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in extending installment options to users, the method comprising:
posting, by a computing device, a record for an installment option to an immutable data structure, the record including a total amount, payment terms associated with multiple installments, a first hashed value associated with a first party, and an identifier of the first party;
receiving, by the computing device, a request related to the record, the request including a secret and a second hashed value;
validating, by the computing device, the request based on the secret and the first hashed value included in the immutable data structure; and
in response to validation of the request:
coordinating a fund transfer consistent with the request; and
updating the record included in the immutable data structure to include the second hashed value for the identifier of the first party.

2. The computer-implemented method of claim 1, wherein posting the record includes posting the record, via an application programming interface (API), to the immutable data structure.

3. The computer-implemented method of claim 1, wherein validating the request includes:
hashing the secret included in the request; and
comparing the hashed secret to the first hashed value.

4. The computer-implemented method of claim 2, wherein hashing the secret includes hashing the secret based on a secure hashing algorithm (SHA).

5. The computer-implemented method of claim 1, wherein the record further includes a balance due; and
wherein the payment terms include a number of minimum payments and an interval of the payments.

6. The computer-implemented method of claim 1, wherein the request includes a request for a lender to pay into the contract; and
wherein the fund transfer incudes a fund transfer from the lender to the first party.

7. The computer-implemented method of claim 1, wherein the request includes a request for repayment from a lender associated with the installment option; and
wherein the fund transfer incudes a fund transfer from the record to the lender.

8. The computer-implemented method of claim 7, wherein updating the record includes updating a balance due on the installment contract in the record.

9. A non-transitory computer-readable storage medium including executable instructions, which when executed by at least one processor for use in extending installment options to users, cause the at least one processor to:
post a record for an installment option to an immutable data structure, the record including a total amount, payment terms associated with multiple installments, a first hashed value associated with a first party, and an identifier of the first party;
receive a request related to the record, the request including a secret and a second hashed value;
validate the request based on the secret and the first hashed value included in the immutable data structure; and
based on validation of the request:
coordinate a fund transfer consistent with the request; and
update the record included in the immutable data structure to include the second hashed value in association with the identifier of the first party.

10. The non-transitory computer-readable storage medium of claim 9, wherein the executable instructions, when executed by the at least one processor to post the record, cause the at least one processor to post the record via an application programming interface (API) to the immutable data structure.

11. The non-transitory computer-readable storage medium of claim 9, wherein the executable instructions, when executed by the at least one processor to validate the request, cause the at least one processor to:
hash the secret included in the request; and
compare the hashed secret to the first hashed value.

12. The non-transitory computer-readable storage medium of claim 11, wherein the executable instructions, when executed by the at least one processor to hash the secret, cause the at least one processor to hash the secret based on a secure hashing algorithm (SHA).

13. The non-transitory computer-readable storage medium of claim 9, wherein the record further includes a balance due; and
wherein the payment terms include a number of minimum payments and an interval of the payments.

14. The non-transitory computer-readable storage medium of claim 9, wherein the request includes a request for a lender to pay into the contract; and
wherein the fund transfer incudes a fund transfer from the lender to the first party.

15. The non-transitory computer-readable storage medium of claim 9, wherein the request includes a request for repayment from a lender associated with the installment option; and
wherein the fund transfer incudes a fund transfer from the record to the lender.

16. A system for use in extending installment options to users, the system comprising at least one processor configured to:
post a record for an installment option to an immutable data structure, the record including a total amount, payment terms associated with multiple installments, a first hashed value associated with a first party, and an identifier of the first party;
receive a request related to the record, the request including a secret and a second hashed value;
validate the request based on the secret and the first hashed value included in the immutable data structure; and
based on validation of the request:
coordinate a fund transfer consistent with the request; and
update the record included in the immutable data structure to include the second hashed value in association with the identifier of the first party.

17. The system of claim 16, wherein the at least one processor is configured, in order to post the record, to post the record via an application programming interface (API) to the immutable data structure.

18. The system of claim 16, wherein the at least one processor is configured, in order to validate the request, to:
hash the secret included in the request; and
compare the hashed secret to the first hashed value.

19. The system of claim 16, wherein the record further includes a balance due;
wherein the payment terms include a number of minimum payments and an interval of the payments;
wherein the request includes a request for a lender to pay into the contract; and
wherein the fund transfer incudes a fund transfer from the lender to the first party.

20. The system of claim 16, wherein the record further includes a balance due;
wherein the payment terms include a number of minimum payments and an interval of the payments;
wherein the request includes a request for repayment from a lender associated with the installment option; and
wherein the fund transfer incudes a fund transfer from the record to the lender.
